(19) United States
(12) Patent Application Publication
(10) Pub. No.: US 2019/0248187 A1
(43) Pub. Date: Aug. 15, 2019

(54) Tire Having An Optimized Architecture

(71) Applicant: COMPAGNIE GENERALE DES ETABLISSEMENTS MICHELIN, Clermont-Ferrand (FR)

(72) Inventors: Richard ABINAL, Clemont-Ferrand Cedex 9 (FR); Mathieu ALBOUY, Clemont-Ferrand Cedex 9 (FR); François-Xavier BRUNEAU, Clemont-Ferrand Cedex 9 (FR); Cyril CHARREIRE, Clemont-Ferrand Cedex 9 (FR); Pierre FEVRIER, Clemont-Ferrand Cedex 9 (FR); Patrick PALLOT, Clemont-Ferrand Cedex 9 (FR)

(21) Appl. No.: 16/343,552

(22) PCT Filed: Oct. 20, 2017
(86) PCT No.: PCT/FR2017/052887

§ 371 Date: Apr. 19, 2019

(30) Foreign Application Priority Data
Oct. 21, 2016 (FR) 1660246

(51) Int. Cl. B60C 11/03; B60C 1/00; B60C 9/20; B60C 11/00

(52) U.S. Cl. CPC B60C 11/03; B60C 1/0016; B60C 2009/1871; B60C 11/0008; B60C 9/2006

(57) ABSTRACT

Tire (1) for a vehicle, comprising a radially outermost working layer (41) which comprises at least one undulation (412) in line with a rib (26). The undulation (412) is such that it is radially on the outside of the points of the working layer (41) that are in line with the centre of the bottom face (243) of the circumferential groove (25) closest to the undulation (412) and that the minimum radial distance (do), between the radially outer surface of the radially outermost working layer (41) and the tread surface (21) is at least 1 mm less than the radial distance (dc) between the radially outer surface (ROS) of the radially outermost working layer (41) and the tread surface (21), which is the distance in line with the circumferential groove (25) closest to the undulation (412) concerned.

### FIELD OF THE INVENTION

The present invention relates to a tire intended to be fitted to a vehicle, and more particularly to the crown of such a tire.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential median plane referred to as the equatorial plane divides the tire into two substantially symmetrical half-torus shapes, it being possible for the tire to exhibit asymmetries of the tread, of architecture, which are connected with the manufacturing precision or with the sizing.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

In what follows, the expression “in line with” means “for each meridian, radially on the inside within the boundaries of the axial coordinates delimited by”. Thus, “the points of a working layer that are in line with a groove” refer, for each meridian, to the collection of points in the working layer that are radially on the inside of the groove within the boundaries of the axial coordinates delimited by the groove.

A tire comprises a crown comprising a tread that is intended to come into contact with the ground via a tread surface, two beads that are intended to come into contact with a rim, and two sidewalls that connect the crown to the beads. Furthermore, a tire comprises a carcass reinforcement, comprising at least one carcass layer, radially on the inside of the crown and connecting the two beads.

The tread of a tire is delimited, in the radial direction, by two circumferential surfaces of which the radially outermost is the tread surface and of which the radially innermost is referred to as the tread pattern bottom surface. The tread pattern bottom surface, or bottom surface, is defined as being the surface of the tread surface translated radially inwards by a radial distance equal to the tread pattern depth. It is commonplace for this depth to be degressive on the axially outermost circumferential portions, referred to as the shoulders, of the tread.

In addition, the tread of a tire is delimited, in the axial direction, by two lateral surfaces. The tread is also made up of one or more rubber compounds. The expression “rubber compound” refers to a composition of rubber comprising at least an elastomer and a filler.

The crown comprises at least one crown reinforcement radially on the inside of the tread. The crown reinforcement comprises at least one working reinforcement comprising at least one working layer made up of mutually parallel reinforcing elements that form, with the circumferential direction, an angle of between 15° and 50°. The crown reinforcement may also comprise a hoop reinforcement comprising at least one hooping layer made up of reinforcing elements that form, with the circumferential direction, an angle of between 0° and 10°, the hoop reinforcement usually, although not necessarily, being radially on the outside of the working layers.

For any layer of crown, working or other reinforcement reinforcing elements, a continuous surface, referred to as the radially outer surface (ROS) of the said layer, passes through the radially outermost point of each reinforcing element of each meridian. For any layer of crown, working or other reinforcement reinforcing elements, a continuous surface, referred to as the radially inner surface (RIS) of the said layer, passes through the radially innermost point of each reinforcing element of each meridian. The radial distances between a layer of reinforcing elements and any other point are measured from one or other of these surfaces and in such a way as to not incorporate the radial thickness of the said layer. If the other measurement point is radially on the outside of the layer of reinforcing elements, the radial distance is measured from the radially outer surface ROS to this point, and, respectively, from the radially inner surface RIS to the other measurement point if the latter is radially on the inside of the layer of reinforcing elements. This makes it possible to consider radial distances that are coherent from one meridian to the other, without the need to take into consideration possible local variations associated with the shapes of the sections of the reinforcing elements of the layers.

In order to obtain good grip on wet ground, cuts are made in the tread. A cut denotes either a well, or a groove, or a sipe, or a circumferential groove and forms a space opening onto the tread surface.

A sipe or a groove has, on the tread surface, two characteristic main dimensions: a width W and a length Lo, such that the length Lo is at least equal to twice the width W. A sipe or a groove is therefore delimited by at least two main lateral faces determining its length Lo and connected by a bottom face, the two main lateral faces being distant from one another by a non-zero distance referred to as the width W of the sipe or of the groove.

The depth of the cut is the maximum radial distance between the tread surface and the bottom of the cut. The maximum value for the depths of the cuts is referred to as the tread pattern depth D.

A circumferential groove is a groove that is substantially circumferential, the lateral faces are substantially circumferential in the sense that their orientation can vary locally around plus or minus 45° about the circumferential direction but that all of the patterns belonging to the circumferential groove can be found all around the tread, forming a substantially continuous set, which means to say exhibiting discontinuities representing less than 10% by length in comparison with the length of the patterns.

The circumferential grooves delimit ribs. A rib is made up of the tread pattern elements comprised between an axial edge of the tire and the nearest circumferential groove in the axially outwards direction, namely comprised between two adjacent circumferential grooves.

### PRIOR ART

A tire needs to meet numerous performance criteria relating to phenomena such as wear, grip on various types of ground, rolling resistance and dynamic behaviour. These performance criteria sometimes lead to solutions that compromise other criteria. Thus, for good grip performance, the rubber material of the tread needs to be dissipative and soft. In contrast, in order to obtain a tire that performs well in terms of behaviour, notably in terms of dynamic response to transverse loading of the vehicle and therefore loading chiefly along the axis of the tire, the tire needs to have a sufficiently high level of stiffness, notably under transverse load. For a given size, the stiffness of the tire is dependent on the stiffness of the various elements of the tire that are the tread, the crown reinforcement, the sidewalls and the beads. The tread is traditionally stiffened either by stiffening the rubber materials, or by reducing the depth of the tread pattern or by reducing the groove-to-rubber ratio of the tread pattern.

In order to alleviate the problem, tire manufacturers have, for example, changed the rubber material by stiffening it notably using fibres, as mentioned in documents FR 3 014 442 and FR 2 984 230.

These solutions are not always satisfactory. Reducing the tread pattern depth limits the performance in terms of wear and in terms of wet grip. Stiffening the rubber material limits the wet and dry grip capabilities and also increases the tire noise during running. Reducing the void volume of the tread pattern reduces the wet grip capabilities particularly when there is a great depth of standing water. It is also important to maintain a certain thickness of rubber materials between the bottom face of the cuts, grooves or circumferential grooves and the reinforcing elements of the radially outermost crown reinforcement, in order to ensure the durability of the tire.

### SUMMARY OF THE INVENTION

The main objective of the present invention is therefore to increase the performance of the tire in terms of behaviour by improving its grip, and more particularly wet grip, and rolling-resistance performance without altering its wearing and crown-durability performance.

This objective is achieved by a tire comprising:
a tread which is intended to come into contact with the ground via a tread surface,
the tread surface comprising grooves, the grooves forming a space opening onto the tread surface and being delimited by at least two main lateral faces connected by a bottom face,
at least one groove being substantially circumferential, being referred to as a circumferential groove, having a width W, defined by the distance between the two lateral faces, at least equal to 5 mm, and a depth D, defined by the maximum radial distance between the tread surface and the bottom face, at least equal to 4 mm,
at least one rib,
the tire further comprising a crown reinforcement radially on the inside of the tread, and comprising a working reinforcement,
the working reinforcement comprising at least one working layer,
the at least one working layer extending radially from a radially inner surface (RIS) to a radially outer surface (ROS),
the at least one working layer comprising reinforcing elements which are continuous from one axially outer edge of the working layer to the opposite axially outer edge, at least partially made of metal coated in an elastomer material, mutually parallel and which with the circumferential direction (XX′) of the tire form an oriented angle the absolute value of which is at least equal to 15° and at most equal to 50°,
the radially outermost working layer comprising at least one undulation in line with a rib,
the at least one undulation in the radially outermost working layer being such that the working layer portion of the undulation is radially on the outside of the points of the working layer that are in line with the centre of the bottom face of the circumferential groove closest to the said undulation,
the at least one undulation in the radially outermost working layer being such that, in line with the rib on the tread surface comprising an undulation, the minimum radial distance (do), between the radially outer surface (ROS) of the radially outermost working layer and the tread surface, is at least 1 mm less than the radial distance (dc) between the radially outer surface (ROS) of the radially outermost working layer and the tread surface, which is the distance in line with the circumferential groove closest to the undulation concerned,
the minimum radial distance (du) between the radially outer surface (ROS) of the radially outermost layer of the crown reinforcement and the tread surface is at most equal to the depth D of the closest circumferential groove, increased by 2 mm.

In order to improve the dynamic response under axial load, the tire therefore needs to be stiffened in its axial component which, in the case of the crown reinforcement, is essentially given by the stiffness of the metallic working layers and the distance between these and the tread surface. Specifically, the metallic working layers are rigid in tension and in compression because of their materials. They are also rigid in shear because of the angles they make with the circumferential direction and because they are coupled with only a thin thickness of rubber materials between them.

By contrast, the materials between the working layers and the tread surface work in shear under transverse load. The greater the radial thickness of these materials, the less stiff this part of the crown is, and the greater the extent to which the dynamic response performance under axial load is diminished. Therefore it is necessary to reduce this distance. However, it is necessary to maintain the tread pattern depth D in order to preserve the wearing and wet grip performance of the tire.

Moreover, it is necessary to preserve the radial distance (d1), referred to as the beneath-void depth, between the radially outer surface (ROS) of the radially outermost working layer and the bottom face of the circumferential groove, in order to protect the reinforcing elements of the various crown layers from puncturing. One solution to this problem is to leave unchanged the tread pattern depth D and the beneath-void depth (d1) which are measured in line with the major grooves and with the circumferential grooves, and to reduce the radial distance (do) between the working layers and the tread surface in line with those tread portions that are devoid of major grooves and therefore of circumferential grooves.

Bearing in mind the fact that the tread surface of a tire is substantially cylindrical, this solution amounts to undulating the working layers radially according to axial undulations. This solution goes against methods of tire manufacture for which the working layers are laid on substantially cylindrical forms, with their base circular and their generatrix a straight line perpendicular to the base. Tires of the prior art exhibit, after curing, in the meridian planes, a curvature that is even, without a point of inflection or one that is highly localized to the rubber at the edge over less than 10% of the working layer.

Specifically, it is common practice to very locally uncouple certain layers at the ends of the reinforcing elements that form them. These layers are arranged at a substantially constant radius. In the case of the tires according to the invention, these layers are arranged with variations in radius over a minimal surface area in order to provide the expected advantages and exhibit at least one point of inflection in the meridian plane.

On the other hand, having the undulations arranged axially is the method which, using the current type of manufacturing tool, is least expensive in terms of cycle time or in terms of tool modification. Specifically, all that is needed is either a modification to the generatrix of the cylindrical shape, or the laying of circumferential elements of padding rubber.

Moreover, undulating the layers of reinforcing elements subjected to compressive loadings may appear to make the tire more sensitive to variations in the geometry of the tread surface, impairing performance aspects such as uneven wear resistance, out-of-balance, etc. Nevertheless, the solution yields very good performance against these criteria.

In addition, undulating the layers of reinforcing elements subjected to compressive loadings goes against the recommendations for combating the buckling of the structures. Specifically, creating a discontinuity in a radius of curvature amounts to the creation of additional stresses where buckling may occur. However, in the tire, the loadings are very highly localized, which means that part of the crown is in tension when another part is in compression, on a scale that is very much smaller than that of the undulations. Thus, the undulations made within the limits of the invention do not detract from the durability of the tire.

In order to avoid any problem of crown durability associated with impacts as the tire runs along a road surface exhibiting an obstacle, or associated with the fatigue of the rubber material at the end of the reinforcing elements, it is important that the reinforcing elements of the working layer be continuous from one axially outer edge of the working layer to the opposite axially outer edge. The reinforcing elements of the working layer comprise one or more braided or unbraided metallic threads. It is important that these threads be very predominantly continuous across the entire width of the working layer so that the working layer is itself continuous.

Experience shows that in order to improve the performance in terms of dynamic behaviour under transverse load, one of the criteria which is sufficient in itself is to decrease the distance (do) between the radially outer surface (ROS) of the radially outermost working layer and the tread surface. This makes it possible to reduce the sheared thicknesses of rubber materials of the tread and to reduce the production of heat caused by the hysteresis of these materials. These effects are beneficial both with regard to the stiffness of the tread, which is dependent on temperature, and with regard to the rolling resistance and durability performance aspects. Undulating the working layer additionally makes it possible to increase the axial stiffness of the tires by increasing the flexural inertia on the edge of the crown, something which leads to an appreciable improvement in behavioural performance. Moreover, in certain tires, the crown comprises just one working layer, and the invention also works in such cases.

This distance (do) is decreased by creating at least one undulation in the working layer, such that this undulation or undulated part of the working layer is radially on the outside of the part of the working layer that is in line with the circumferential groove closest to the said undulation. It is not a matter of considering as being undulated a working layer that is not undulated but that meets the criterion for reducing the distance (do) by decreasing the tread pattern depth in a given zone. This feature is moreover known notably for tires for passenger vehicles the tread pattern depth of which is smaller on the axially outer edges, known as shoulders, of the tire than in the closest circumferential grooves. In tires according to the prior art, in the part at the shoulders where the radial distance (do) diminishes, the working layer is either at the same radius, or radially on the inside of those parts of the same working layer that are in line with the closest circumferential groove.

The invention also works if one or more undulations are positioned in one or more of the parts of one or more shoulders of the tire.

The beneath-void distance (d1) needs to be maintained in the major grooves and the circumferential grooves. The minor grooves or the sipes are less sensitive to puncturing and to attack from obstacles because they are protected by the rubber material that technically characterizes them as being shallow or narrow grooves.

The layers with a low stiffness, by comparison with the working layers, such as the protective layers, which may or may not be metallic, the hooping layers, containing reinforcing elements that, with the circumferential direction (XX′) of the tire, make an angle B at most equal, in terms of absolute value, to 10°, do not have sufficiently high compression stiffness or shear stiffness, because of their materials, which are sometimes textile, and because of the angles at which they are laid, for undulating these layers alone to afford to the problem a solution that has the same level of effectiveness as does the invention. These protective or hooping layers are optional in a tire and do not govern the benefit of the solution.

It would appear that undulating the radially outer surface of the working layer, in line with just one rib, for example a rib that is central and symmetrical with respect to the median circumferential plane, is enough to register an improvement in dynamic performance under transverse load. This solution may have an advantage in terms of uneven wear, or in terms of axial thrust value depending on the direction of the thrust dependent on the camber angle of the vehicle. Nevertheless, this single undulation may equally be situated under any arbitrary rib and notably under one of the radially outermost ribs. Such choices may be made by taking account of the directional or axisymmetric aspect of the tires and of the camber angle of the car.

The amplitude of this undulation needs to be at least equal to 1 mm in order to have significant effects at tire level, and so the radial distance (do) between the radially outer surface (ROS) of the radially outermost working layer and the tread surface is at least 1 mm less than the radial distance (dc) between the radially outer surface (ROS) of the radially outermost working layer and the tread surface, which is the distance in line with the centre of the bottom face of the circumferential groove closest to the said undulation.

For preference, in line with at least one rib on the tread surface comprising an undulation, the minimum radial distance (do) between the radially outer surface (ROS) of the radially outermost working layer and the tread surface is at least 1.5 mm, and preferably 2 mm, less than the radial distance (dc) between the radially outer surface of the radially outermost working layer and the tread surface, which is the distance in line with the circumferential groove closest to the undulation concerned. The design parameters that make it possible to regulate the dynamic response under significant transverse load, representing at least of the order of 50% of the nominal tire load, are:
The number of ribs and the dimension of the undulations of the radially outermost working layer. The more extensive the undulation, the stiffer the tire under transverse load, and the better its rolling resistance performance. One single rib may represent 15% of the axial width of the radially outermost working layer. It is commonplace to have 3, 4 to 5 ribs and for the circumferential grooves to represent around 20% of this width.
The amplitude of the undulation is at least equal to 1 mm, but limited to 5 mm because of the radii of curvature that have to be imparted to the metallic working layers which are stiff and therefore not very deformable.

One preferred solution is therefore that, in line with at least one rib on the tread surface comprising an undulation, the radial distance (do) between the radially outer surface (ROS) of the radially outermost working layer and the tread surface is at most 5 mm, and preferably 3 mm, less than the radial distance (dc) between the radially outer surface (ROS) of the radially outermost working layer and the tread surface, which is the distance in line with the circumferential groove closest to the undulation concerned.

For optimum performance in terms of puncturing and attack of the crown, without penalizing the rolling resistance, the radial distance (d1) between the radially outer surface (ROS) of the radially outermost working layer and the bottom face of the circumferential grooves is at least equal to 1 mm and at most equal to 5 mm, preferably at least equal to 2 mm and at most equal to 4 mm. Below the lower limits, the tire may prove too sensitive to attack. Above the upper limits, the rolling resistance of the tire would be penalized.

It is advantageous for an undulation of the radially outermost working layer to be present in line with all the ribs on the tread surface, in order to extend the advantage of the solution to its best.

One preferred solution is for an undulation of the radially outermost working layer to be present only in line with the ribs on the tread surface that are axially closest to the median circumferential plane, on each side of this plane, in order to obtain just enough of a performance advantage with respect to the increase in manufacturing on-cost that undulating the radially outermost working layer represents.

It is advantageous for the tread, for example in a groove or a circumferential groove of the tread, to comprise at least one wear indicator, and for the minimum radial distance (du) between the radially outer surface (ROS) of the radially outermost layer of the crown reinforcement and the tread surface to be at least equal to the radial distance (df) between the tread surface and the radially outermost point of the wear indicator. Specifically, it is important for the user to be able to perceive that the tire is worn, using the wear indicator, and to be able to do so before the reinforcing elements of the radially outermost layer of the crown reinforcement begin to appear on the tread surface.

Advantageously, the minimum radial distance (du) between the radially outer surface (ROS) of the radially outermost layer of the crown reinforcement and the tread surface is at most equal to the depth D of the closest circumferential groove, increased by 2 mm, and at least equal to the depth D of the closest circumferential groove, decreased by 2 mm. This solution allows ideal positioning of the radially outermost layer of reinforcing elements of the crown reinforcement, and the tread surface. The minimum radial distance (du) between the radially outer surface (ROS) of the radially outermost layer of the crown reinforcement and the tread surface has to be measured over the radially outer portion of the crown reinforcement, and therefore at an undulation.

For preference, the depth D of a major groove or of a circumferential groove is at least equal to 6 mm and at most equal to 20 mm. Tread pattern depths of between 6 and 10 mm allow a good compromise between wearing and rolling resistance performance aspects in many passenger vehicle tires. Tread pattern depths of between 10 and 20 mm are attractive for the same compromises in tires for vehicles that carry heavy loads. The invention is not restricted to tires for a particular use.

In instances in which the radially outermost layer of reinforcing elements is a hooping layer, it is advantageous for the radially outermost layer of reinforcing elements in the crown reinforcement to comprise reinforcing elements made of textile, preferably of the aliphatic polyamide, aromatic polyamide type, of a type involving a combination of aliphatic polyamide and aromatic polyamide, of polyethylene terephthalate or of rayon type, which are mutually parallel and form, with the circumferential direction (XX′) of the tire, an angle B at most equal to 10°, in terms of absolute value,

One preferred solution is for at least one element of padding rubber, having a radial thickness at least equal to 0.3 mm, to be positioned in line with any undulation of the radially outermost working layer. The purpose of this is to allow the plies to undulate during building and curing. It is possible to lay several elements of padding rubber in line with the one or more undulations with different radius values having different properties dependent on the tire loading specification sheet. If a single element of padding rubber is laid, its maximum thickness is approximately equal, for a given undulation, to the radial distance between the radially outermost point of the radially outer surface of the radially outermost working layer at the undulation and the radially outer surface of the radially outermost working layer in line with the centre of the bottom face of the major groove closest to the said undulation.

With the tread being made up of a rubber compound, it is advantageous for the element of padding rubber, laid in line with the undulation or undulations, to be a rubber compound that has a dynamic loss tan δ1, measured at a temperature of 10° C. and under a stress of 0.7 MPa at 10 Hz, at most equal to and preferably 30% less than the dynamic loss tan δ2 of the rubber material of which the tread is made, measured at a temperature of 10° C. and under a stress of 0.7 MPa at 10 Hz. For a padding material with the same hysteresis, the improvement in terms of rolling resistance is achieved only by the reduction in the shear stress loadings that this material experiences. Because the padding material does not experience the same stresses as the rubber material of which the tread is made, it is possible to modify its characteristics in order to improve the rolling resistance still further. A 30% drop in hysteresis leads to a significantly higher improvement for the invention.

It is preferable for the crown reinforcement to consist of 2 working plies of opposite angles and one hooping ply, as in numerous present-day crown architectures.

Advantageously, the elements of padding rubber in line with the undulations are radially on the inside of all the working layers of the working reinforcement so that the working layers are at no point uncoupled from the crown by these elements of padding rubber. This arrangement guarantees the crown a high level of transverse stiffness.

In order not to create excessively large radii of curvature in the carcass reinforcement which could locally give rise to buckling because of the compressive loadings to which the carcass reinforcement is subjected, one solution is to arrange the elements of padding rubber in line with the undulations radially on the outside of the carcass layers that make up the carcass reinforcement.

### BRIEF DESCRIPTION OF THE DRAWINGS

The features and other advantages of the invention will be understood better with the aid of FIGS. 1 to 5, the said figures being drawn not to scale but in a simplified manner so as to make it easier to understand the invention:

FIG. 1 is part of a tire, particularly the architecture, the tread and a circumferential groove (25) and a rib (26) thereof.

FIG. 2 depicts a meridian section through the crown of a tire according to the invention, with an undulation under a rib (26), and illustrates the various radial distances do, d1, D, du, dc and an element of padding rubber (6) capable of creating an undulation (412) in the radially outermost working layer.

FIG. 3 depicts a meridian section through the crown of a tire according to the invention, with an undulation under each rib (26), it being possible for each rib to have a different radial thickness and axial width, as well as radial distance df.

FIG. 4 depicts a meridian section through the crown of a tire according to the invention, with an undulation under each of the ribs (26) axially closest to the median circumferential plane.

FIG. 5 depicts a meridian section through the crown of a tire according to the invention with an undulation under certain ribs (26), the elements of padding rubber all being radially on the inside of the working layers and radially on the outside of the carcass layer (8) constituting the carcass reinforcement.

Numerous combinations of arrangements and dimensions of the undulations under the ribs are possible. The figures and the description do not attempt to describe all of these explicitly.

### DETAILED DESCRIPTION OF THE DRAWINGS

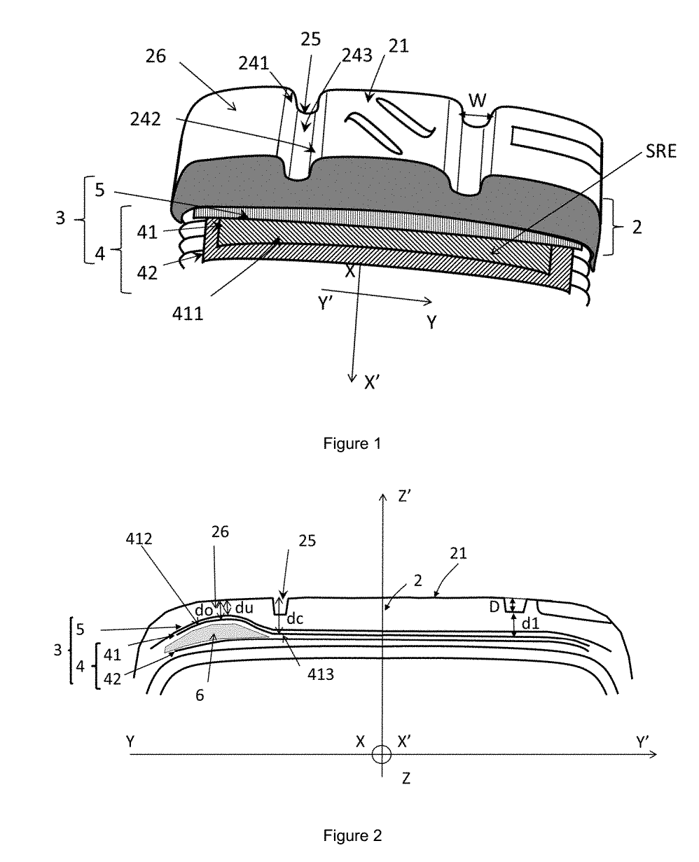

FIG. 1 depicts a perspective view of a part of the crown of a tire. A cartesian frame of reference (XX′, YY′, ZZ′) is associated with each meridian plane. The tire comprises a tread 2 which is intended to come into contact with the ground via a tread surface 21. Arranged in the tread are grooves and circumferential grooves 25 of width W possibly differing from one circumferential groove to another, each having main profiles 241 and 242 and a bottom face 243. The tire further comprises a crown reinforcement 3 comprising a working reinforcement 4 and here, by way of example, a hoop reinforcement 5. The working reinforcement comprises at least one working layer and here, for example, two working layers 41 and 42 each comprising mutually parallel reinforcing elements. The radially outer surface ROS of the radially outermost working layer 41 is also depicted.

FIG. 2 depicts a schematic meridian section through the crown of the tire according to the invention. It illustrates in particular an undulation of the radially outermost working layer 41 and an element of padding rubber 6 positioned in line therewith. FIG. 2 also illustrates the following radial distances:
D: the depth of a groove, which is the maximum radial distance between the tread surface 21 and the bottom face 243 of the circumferential groove 25,
dc: the radial distance between the radially outer surface ROS of the radially outermost working layer 41 and the tread surface 21, which is the distance in line with the centre of the bottom face 243 of the circumferential groove 25 closest to the said undulation 412.
df: the radial distance between the tread surface (21) and the radially outermost point of the wear indicator (7).
do: the radial distance between the radially outer surface ROS of the radially outermost working layer 41 and the tread surface at the undulation 412.
du: the minimum radial distance between the radially outer surface (ROS) of the radially outermost layer of the crown reinforcement 3 and the tread surface 21.
d1: the radial distance between the radially outer surface ROS of the radially outermost working layer 41 and the bottom face 243 of the circumferential grooves 25.

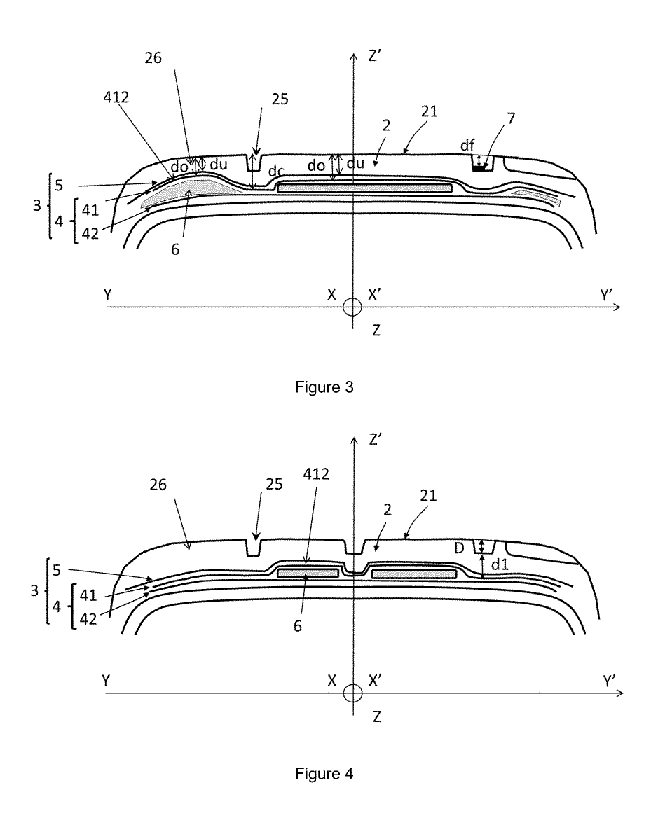

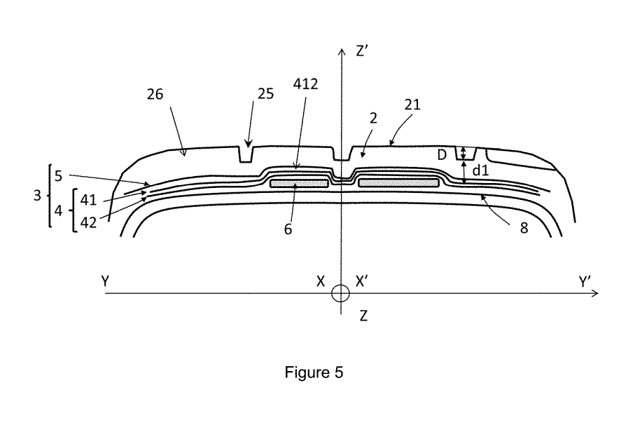

FIG. 3 depicts a schematic meridian section through the crown of the tire according to the invention. It illustrates in particular, df: the radial distance between the tread surface 21 and the radially outermost point of the wear indicator 7.

A meridian section through the tire is obtained by cutting the tire on two meridian planes. This section is used to determine the various radial distances, the centre of the bottom faces of the grooves and of the circumferential grooves.

The invention was carried out on a tire A of size 305/30 ZR20 intended to be fitted to a passenger vehicle. The depths D of the grooves of the tread pattern are comprised between 4 and 7 mm and equal to 7 mm in the case of the circumferential grooves, for widths W which are variable in the case of the grooves and equal to 15 mm in the case of the circumferential grooves. The crown reinforcement is made up of two working layers the reinforcing elements of which make an angle of + or −38° with the circumferential direction and of a hooping layer the reinforcing elements of which make an angle of + or −3° with the circumferential direction. The reinforcing elements of the working layer are continuous metallic cords.

The radially outermost working layer is undulated under the 5 ribs of the tread. The radial distance (do) between the radially outer surface (ROS) of the radially outermost working layer (41) and the tread surface is 2 mm less than the radial distance (dc) between the radially outer surface (ROS) of the radially outermost working layer (41) and the tread surface, which is the distance in line with the centre of the bottom face (243) of the circumferential groove (25) closest to the undulation in the case of the 3 axially inner ribs, and 1 mm in the case of the 2 axially innermost ribs. Likewise, the axial width of the undulations is equal to 21 mm for the 3 axially inner ribs and equal to 7 mm for the 2 axially outermost ribs. The radial distance (d1) between the radially outer surface (ROS) of the radially outermost working layer (41) and the bottom face (243) of the circumferential grooves (25) is comprised between 2 mm and 3.5 mm.

The undulations are created using elements of padding rubber laid in line with the 5 ribs of the tread. These elements of padding rubber are radially on the outside of the carcass layer and radially on the inside of the two working layers thereby ensuring a flat geometry under the crown, optimal carcass layer geometry and optimal coupling between the said working layers.

Tires A were compared with tires B of the same size, having the same characteristics except that the working layers were not undulated.

The padding compound used to create the undulations has a dynamic loss tan δ1, measured at a temperature of 10° C. and under a stress of 0.7 MPa at 10 Hz, 60% less than that of the rubber material of which the tread is made.

The improvement in terms of rolling resistance was evaluated on a standard machine for measurements standardized in accordance with ISO 2850:2009. The tests reveal a more than 10% improvement by comparison with the reference tire B.

Furthermore, a measurement of the characteristic Dz of the Pacejka tire behaviour model well known to those skilled in the art reveals a 13% improvement in this characteristic for a pressure of 2.6 b, hot. The improvement in dry grip varies between 1 and 5% depending on the stress loading conditions.

The tires were also fitted to a sports-type vehicle and tested on a winding circuit capable of generating significant transverse loadings. A professional driver, trained in assessing tires, compares tires A according to the invention with tires B according to the prior art and according to a rigourous testing process, under the same temperature conditions and ground running conditions, without knowing the features of the tires being tested, repeating the measurement. The driver assigns scores to the tires. In all the tests performed, tires A according to the invention outclass tires B in terms of vehicle behaviour, roadholding, on dry ground and in terms of grip. Furthermore, the behavioural performance is more constant during a behaviour test on a vehicle fitted with a tire according to the invention than with a tire according to the prior art.

1. Tire for a vehicle, comprising:
a tread which is adapted to come into contact with the ground via a tread surface;
the tread surface comprising grooves, the grooves forming a space opening onto the tread surface and being delimited by at least two main lateral faces connected by a bottom face;
at least one said groove being substantially circumferential, being referred to as a circumferential groove, having a width W, defined by the distance between the two lateral faces, at least equal to 5 mm, and a depth D, defined by the maximum radial distance between the tread surface and the bottom face, at least equal to 4 mm,
at least one rib;
the tire further comprising a crown reinforcement radially on the inside of the tread, and comprising a working reinforcement;
the working reinforcement comprising at least one working layer;
the at least one working layer extending radially from a radially inner surface to a radially outer surface; and
the at least one working layer comprising reinforcing elements which are continuous from one axially outer edge of the working layer to the opposite axially outer edge, at least partially made of metal coated in an elastomer material, mutually parallel and which with the circumferential direction (XX′) of the tire form an oriented angle the absolute value of which is at least equal to 15° and at most equal to 50°,
wherein the radially outermost working layer comprises at least one undulation in line with a rib,
wherein the at least one said undulation in the radially outermost working layer is such that the working layer portion of the undulation is radially on the outside of the points of the working layer that are in line with the centre of the bottom face of the circumferential groove closest to said undulation,
wherein the at least one said undulation in the radially outermost working layer is such that, in line with the rib on the tread surface comprising an undulation, the minimum radial distance, between the radially outer surface of the radially outermost working layer and the tread surface, is at least 1 mm less than the radial distance (dc) between the radially outer surface of the radially outermost working layer and the tread surface, which is the distance in line with the circumferential groove closest to undulation concerned, and
wherein the minimum radial distance between the radially outer surface of the radially outermost layer of the crown reinforcement and the tread surface is at most equal to the depth D of the closest circumferential groove, increased by 2 mm.

2. The ire according to claim 1, wherein, in line with at least one said rib on the tread surface comprising an undulation, the minimum radial distance between the radially outer surface of the radially outermost working layer and the tread surface is at least 1.5 mm, less than the radial distance (dc) between the radially outer surface of the radially outermost working layer and the tread surface, which is the distance in line with the circumferential groove closest to the undulation concerned.

3. The tire according to claim 1, wherein, in line with at least one said rib on the tread surface comprising an undulation, the radial distance between the radially outer surface of the radially outermost working layer and the tread surface is at most 5 mm less than the radial distance between the points on the radially outer surface of the radially outermost working layer and the tread surface, which is the distance in line with the circumferential groove closest to the undulation concerned.

4. The tire according to claim 1, wherein the radial distance between the radially outer surface of the radially outermost working layer and the bottom face of the circumferential grooves is at least equal to 1 mm and at most equal to 5 mm.

5. The tire according to claim 1, wherein a said undulation of the radially outermost working layer is present in line with all the ribs on the tread surface.

6. The tire according to claim 1, wherein a said undulation of the radially outermost working layer is present only in line with the ribs on the tread surface that are axially closest to the median circumferential plane, on each side of this plane.

7. The tire having wear indicators according to claim 1, wherein the radial distance between the radially outer surface of the radially outermost layer of the crown reinforcement and the tread surface is at least equal to the radial distance between the tread surface and the radially outermost point of the wear indicators.

8. The tire according to claim 1, wherein the minimum radial distance between the radially outer surface of the radially outermost layer of the crown reinforcement and the tread surface is at least equal to the depth D of the closest circumferential groove, decreased by 2 mm.

9. The tire according to claim 1, wherein the depth D of the at least one circumferential groove is at least equal to 6 mm and at most equal to 20 mm.

10. The tire according to claim 1, wherein the radially outermost layer of the working reinforcement is comprised of reinforcing elements comprised of textile of a type involving a combination of aliphatic polyamide and aromatic polyamide, of polyethylene terephthalate or of rayon type, which are mutually parallel and form, with the circumferential direction of the tire, an angle B at most equal to 10°, in terms of absolute value.

11. The tire according to claim 1, wherein at least one element of padding rubber, having a radial thickness at least equal to 0.3 mm, is in line with any said undulation of the radially outermost working layer.

12. The tire according to claim 11, the tread being comprised of a rubber compound, wherein the element of padding rubber is a rubber compound that has a dynamic loss tan δ1, measured at a temperature of 10° C. and under a stress of 0.7 MPa at 10 Hz, at most equal to the dynamic loss tan δ2 of the rubber material of which the tread is made, measured at a temperature of 10° C. and under a stress of 0.7 MPa at 10 Hz.

13. The tire according to claim 1, wherein the crown reinforcement consists of 2 working plies of opposite angles and one hooping ply.

14. The tire according to claim 1, wherein the elements of padding rubber are radially on the inside of all the working layers of the working reinforcement.

15. The tire according to claim 1, wherein, in line with at least one said rib on the tread surface comprising an undulation, the minimum radial distance between the radially outer surface of the radially outermost working layer and the tread surface is at least 2 mm less than the radial distance between the radially outer surface of the radially outermost working layer and the tread surface, which is the distance in line with the circumferential groove closest to the undulation concerned.

16. The tire according to claim 1, wherein, in line with at least one said rib on the tread surface comprising an undulation, the radial distance between the radially outer surface of the radially outermost working layer and the tread surface is at most 3 mm less than the radial distance between the points on the radially outer surface of the radially outermost working layer and the tread surface, which is the distance in line with the circumferential groove closest to the undulation concerned.

17. The tire according to claim 1, wherein the radial distance between the radially outer surface of the radially outermost working layer and the bottom face of the circumferential grooves is at least equal to 2 mm and at most equal to 4 mm.

18. The tire according to claim 1, wherein the radially outermost layer of the working reinforcement is comprised of reinforcing elements comprised of textile, of the aliphatic polyamide, aromatic polyamide type, of a type involving a combination of aliphatic polyamide and aromatic polyamide, of polyethylene terephthalate or of rayon type, which are mutually parallel and form, with the circumferential direction of the tire, an angle B at most equal to 10°, in terms of absolute value.

19. The tire according to claim 11, the tread being comprised of a rubber compound, wherein the element of padding rubber is a rubber compound that has a dynamic loss tan δ1, measured at a temperature of 10° C. and under a stress of 0.7 MPa at 10 Hz, at most 30% less than the dynamic loss tan δ2 of the rubber material of which the tread is made, measured at a temperature of 10° C. and under a stress of 0.7 MPa at 10 Hz.
